(19) United States
(12) Patent Application Publication
(10) Pub. No.: US 2004/0099287 A1
(43) Pub. Date: May 27, 2004

(54) Dishwasher control method and dishwasher using the same

(76) Inventor: Dong Hoon Shin, Changwon-si (KR)

Correspondence Address: Song K. Jung, McKENNA LONG & ALDRIDGE LLP, 1900 K Street, N.W., Washington, DC, 20006, US

(21) Appl. No.: 10/717,666

(22) Filed: Nov. 21, 2003

(30) Foreign Application Priority Data
Nov. 25, 2002 (KR) P 2002-73581

(51) Int. Cl. B08B 7/04; B08B 9/20

(52) U.S. Cl. 134/18; 134/25.2

(57) ABSTRACT

A dishwasher control method and dishwasher using the same is provided, by which product cost of the dishwasher is reduced as well as a water supply amount is optimized. The method includes steps of supplying water to a washtub for a first predetermined time period; driving a wash motor when the first predetermined time period has elapsed; determining an electrical characteristic of the driven wash motor; comparing a value indicative of the determined electrical characteristic with a predetermined value indicative of a desired electrical characteristic of the wash motor; and discontinuing the water supplying step if the determined electrical characteristic value is not less than the predetermined value for a second predetermined time period. If the determined electrical characteristic value fails to reach the predetermined value before a lapse of a third predetermined time period, the wash motor is stopped and a water supply error message is displayed.

This application claims the benefit of Korean Application No. 10-2002-0073581 filed on Nov. 25, 2002, which is hereby incorporated by reference.

### BACKGROUND OF THE INVENTION

1. Field of the Invention

The present invention relates to a dishwasher, and more particularly, to a dishwasher control method, and a dishwasher using the same, employing a wash motor current detector utilized in conjunction with an internal control program.

2. Discussion of the Related Art

A dishwasher is a cleaning apparatus for removing meal residue attached to tableware. FIGS. 1 and 2 illustrate such a dishwasher 100 according to the related art.

The dishwasher 100 is comprised of a key input unit 1 for inputting a user command; a controller 6 for controlling the overall system according to a key signal from the key input unit 1 and an internal program; a driver 2 for driving various loads 3 according to a control signal from the controller 6, including a wash motor 3a actuating a wash pump, a supply valve 3b of a solenoid type, a drain valve 3c of a solenoid type, and a heater 3d; a water level detector 4 for detecting a water level in a water reservoir 8, which is a recess formed in a washtub 200 where the supplied water first pools; and a display 5 for displaying various states of the dishwasher. Though not specifically shown, the wash motor 3a is set within the recess of the washtub 200. A water supply 7 provides the dishwasher 100 with a steady water supply via a connecting hose to the washtub 200. A plurality of nozzles 300 are provided within the washtub 200 for spraying water via the wash motor 3a under the control of the controller 6. The water level detector 4 is realized using a pressure switch for sensing the water level according to water pressure or a flow meter for outputting an oscillation frequency according to water pressure variation.

In the operation of the above dishwasher, water is supplied to a predetermined level in the water reservoir 8 through the supply valve 3b in accordance with a control signal from the controller 6. The heater 3d is then driven to heat the supplied water. The wash motor 3a is actuated to pump the heated water through the wash pump (not shown), to be sprayed through the nozzles 200 onto tableware placed on a shelf in the washtub 100. Subsequently, cold water is supplied to be sprayed onto the tableware for rinsing. Upon completing the rinsing step, the cold water is heated in order to spray hot water onto the tableware, which imparts the tableware with a latent heat to dry the water content thereon, thus completing the wash cycle.

In detail, a user inputs via the key input unit 1 a desired command based on such factors as the amount and type of tableware to be cleaned, and the driver 2 is controlled accordingly. That is, the load driver 2 controls the supply valve 3b according to the control signal of the controller 6, to supply the water reservoir 8 with the water from the water supply 7, and the water level detector 4 detects the varying water level in the water reservoir. When the water in the water reservoir 8 reaches a predetermined level, the controller 6 stops supplying the water and the heater 3d is driven to heat the collected water. The wash motor 3a is then driven so that the nozzles 300 are supplied with the water through the wash pump and the water is sprayed onto the tableware to perform washing. Subsequently, rinse and dry steps are carried out, after which the used water in the washtub 200 is discharged through the drain valve 3c.

The above predetermined level of water in the water reservoir 8 may be determined automatically based on the user command input according to the desired dishwashing process and the dishwasher model specifications, such as water passage sizes and nozzle capacity. In other dishwasher models, the user may manually select the water supply amount among a number of predetermined levels.

Referring to FIG. 3, a control method of a dishwasher according to the related art includes a water supplying step S1, a water level determining step S2, a water supply shutoff step S3, and a water motor driving step S4. Upon input of a user command, water is supplied to the water reservoir 8, and the water level therein is monitored. When the water level reaches a predetermined level, set according to specification and/or a user command, the water supply is shut off and the wash motor 3a is driven, thus actuating the wash pump to execute washing, rinsing, and drying processes accordingly.

The related art dishwasher as above, however, requires water level detection means, i.e., a pressure switch or flow meter, which increases the dishwasher's design and manufacturing costs. Moreover, there are naturally cases where the predetermined water level set as above may be too low or too high when the motor driving step S1 is performed. For lower water levels, which may result if the water supply pressure is low, air often reaches the wash pump together with the water, which decreases the nozzle pressure and in turn degrades washing performance and generates an air suction noise. For higher water levels, the amount of water used is unnecessarily increased, which increases its heating time and wastes energy.

### SUMMARY OF THE INVENTION

Accordingly, the present invention is directed to a dishwasher control method and dishwasher using the same that substantially obviates one or more of the problems due to limitations and disadvantages of the related art.

An object of the present invention, which has been devised to solve the foregoing problems, lies in providing a dishwasher and control method thereof, by which product cost is reduced and water supply is optimized.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a method of controlling a dishwasher. The method comprises steps of supplying water to a washtub for a first predetermined time period; driving a wash motor when the first predetermined time period has elapsed; determining an electrical characteristic of the driven wash motor; comparing a value indicative of the determined electrical characteristic with a predetermined value indicative of a desired electrical characteristic of the wash motor; and discontinuing the water supplying step if the determined electrical characteristic value is not less than the predetermined value for a second predetermined time period. The method further comprises a step of stopping the wash motor and simultaneously displaying a water supply error message if the determined electrical characteristic value fails to reach the predetermined value before a lapse of a third predetermined time period.

Preferably, the determined electrical characteristic is detected by current detection means.

In another aspect of the present invention, there is provided a dishwasher employing the above method. The dishwasher comprises: a washtub for holding tableware; a wash motor, installed in the washtub, for actuating a wash pump; a detector for detecting an electrical characteristic of the wash motor; a controller, coupled to the wash motor, for outputting a valve control signal based on the detected electrical characteristic of the wash motor; and a solenoid valve for controlling a water supply to the washtub based on the valve control signal output from the controller.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view of a dishwasher according to a related art;

FIG. 2 is a block diagram of a dishwasher according to a related art;

FIG. 3 is a flowchart of a method of controlling a dishwasher according to a related art;

FIG. 4 is a block diagram of a dishwasher according to the present invention;

FIG. 5 is a flowchart of a method of controlling a dishwasher according to the present invention; and

FIG. 6 is a graph of sample electrical characteristics of a wash motor according to the present invention, where a water supply error state exists.

### DETAILED DESCRIPTION OF THE PREFERRED EMBODIMENT

Reference will now be made in detail to the preferred embodiment of the present invention, examples of which are illustrated in the accompanying drawings. Throughout the drawings, like elements are indicated using the same or similar reference designations where possible.

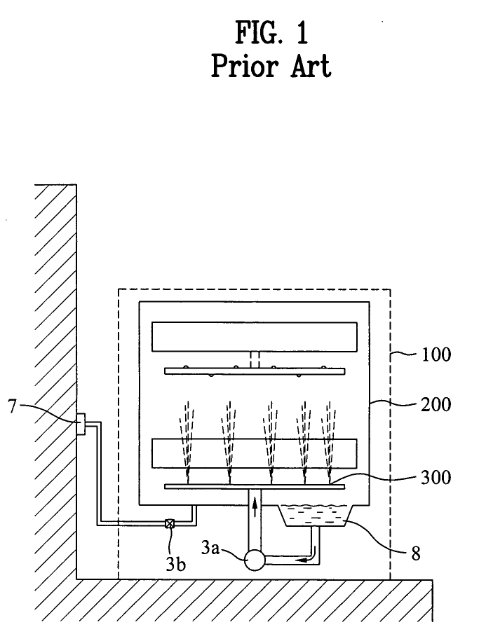

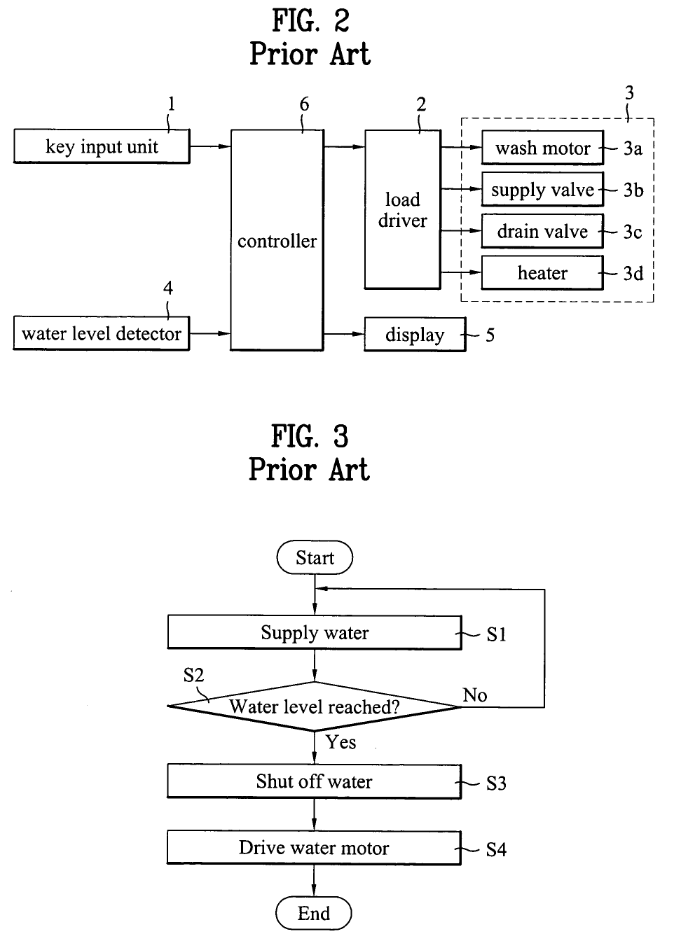

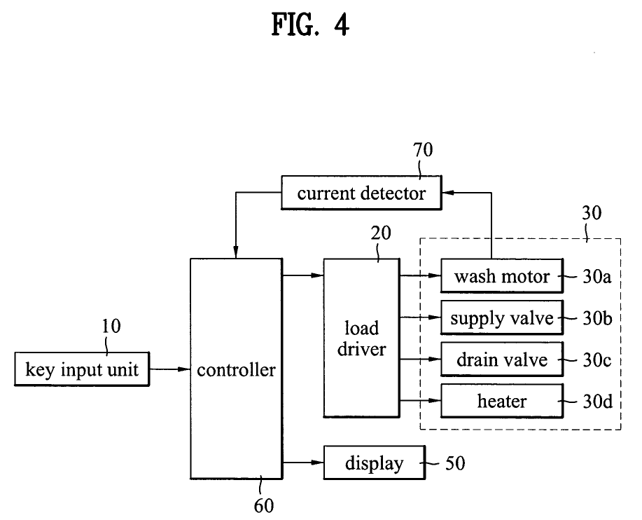

FIG. 4 is a block diagram of a dishwasher according to the present invention, by which dishwasher construction and operation are explained with reference to FIG. 1.

The dishwasher according to the present invention is comprised of a key input unit 10 for inputting a user command, a load driver 20 for driving various loads 30 including a wash motor 30a, supply valve 30b, drain valve 30c, and heater 30d according to the user command input, a current detector 70 for detecting an electrical characteristic of the wash motor as it is driven, a controller 60 for controlling the overall system according to a key signal from the key input unit and an internal program and specifically for outputting a plurality of control signals to the load driver to execute the steps of the internal program based on the detected electrical characteristic, and a display 50 displaying various statuses of the dishwasher.

The internal program of the controller 60 stores a first predetermined time, which is set according to model specifications. The first predetermined time period is the time required under normal conditions for the supplied water to reach a level sufficient for submerging a mechanical seal (not shown) of the wash motor 30a. The drive of the wash motor 30a is begun only after the first predetermined time period has elapsed, to prevent a breakdown of the mechanical seal.

A predetermined value E1 is also set according to model specifications. The predetermined value E1 is an electrical characteristic of the wash motor 30a, i.e., a current level sufficient to drive the wash motor such that the above level is reached during a second predetermined time period.

In the operation of the above-constituted dishwasher according to the present invention, a user inputs a wash command through the key input unit 10, and the controller 60 controls the load driver 20 according to the wash command, to drive the supply valve 30b and thereby start supplying the water to the water reservoir 8 via the washtub 200. The supply valve 30b is held open for a first predetermined time. Thereafter, the controller 60 controls the load driver 20 to drive the wash motor 30a and the supply valve 30b, based on the current draw of the wash motor, i.e., an electrical characteristic E2 as detected by the current detector 70. The controller 60 receives the electrical characteristic E2 from the current detector 70 and compares it to the predetermined value E1. If the detected value E2 reaches the predetermined value E1 and the current level is maintained for the second predetermined time period, the supply valve 30b is shut off and subsequent steps of washing, rinsing, and drying are sequentially executed.

On the other hand, if the detected value E2 is less than the predetermined value E1 for a third predetermined time period, it is determined that the amount of water supplied is insufficient. This insufficient water supply would result in an adverse condition such as air suction noise. Hence, the wash motor 30a is stopped if the detected value E2 fails to reach the predetermined value E1 after the lapse of the third predetermined time period, and a water supply error message is displayed on the display 50.

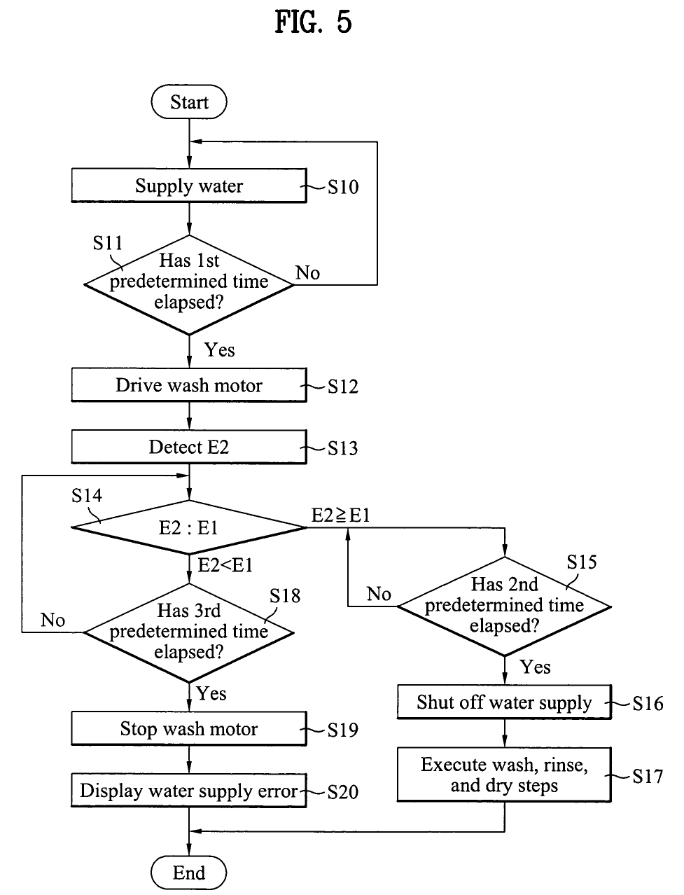

Referring to FIG. 5, illustrating the dishwasher control method according to the present invention, the supply valve 30b is operated in a step S11 upon input of an appropriate user command, and water is supplied for the first predetermined time period according to a step S11. Then, the wash motor 3a is driven in a step S12.

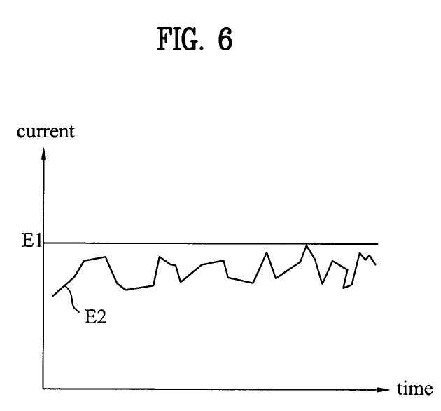

As the wash motor 30a is driven, the current detector 70 detects the electrical characteristic E2 in a step S13. In a step S14, the value of electrical characteristic E2 is compared to the predetermined value E1, to determine whether the current (E2) of the wash motor 30a reaches a sufficient current level (E1) for driving the wash motor as necessary. FIG. 6 illustrates a sample detection condition where the current value of E2 has failed to reach the current value of E1 over time.

Assuming a normal operating condition where the detected value E2 is not less than the predetermined value E1, i.e., E2 E1, it is determined in a step S5 whether the normal operating condition is maintained for the second predetermined time period. In this case, the water supply is shut off in a step S16 and the wash, rinse, and dry steps are sequentially executed in a step S17.

On the other hand, if it is determined in the step S14 that the detected value E1 fails to reach the predetermined value E2, i.e., E2<E1, the water supply of the step S10 is continued in a step S18 for the third predetermined time period. If the fail condition persists, the wash motor 30a is stopped in a step S19 and a water supply error message is displayed in a step S20.

By adopting the dishwasher control method of the present invention, water is supplied optimally and the wash step executed without the water level detection means of the related art and thereby reduce design and manufacturing costs accordingly. By supplying the optimum amount of water necessary for washing, water and energy consumption are conserved and air suction noise is prevented.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A method of controlling a dishwasher, comprising steps of:
supplying water to a washtub for a first predetermined time period;
driving a wash motor when the first predetermined time period has elapsed;
determining an electrical characteristic of said driven wash motor;
comparing a value indicative of the determined electrical characteristic with a predetermined value indicative of a desired electrical characteristic of said wash motor; and
discontinuing said water supplying step if the determined electrical characteristic value is not less than the predetermined value for a second predetermined time period.

2. The method as claimed in claim 1, further comprising a step of stopping said wash motor and simultaneously displaying a water supply error message if the determined electrical characteristic value fails to reach the predetermined value before a lapse of a third predetermined time period.

3. The method as claimed in claim 1, wherein the determined electrical characteristic is detected by current detection means.

4. A dishwasher comprising:
a washtub for holding tableware;
a wash motor, installed in said washtub, for actuating a wash pump;
a detector for detecting an electrical characteristic of said wash motor;
a controller, coupled to said wash motor, for outputting a valve control signal based on the detected electrical characteristic of said wash motor; and
a solenoid valve for controlling a water supply to said washtub based on the valve control signal output from said controller.
